(19) United States
(12) Patent Application Publication
(10) Pub. No.: US 2018/0339180 A1
(43) Pub. Date: Nov. 29, 2018

(54) WILDFIRE SUPPRESSION SYSTEM

(71) Applicant: JUNATA E. WEBER, ST. LOUIS, MO (US)

(72) Inventor: JUNATA E. WEBER, ST. LOUIS, MO (US)

(21) Appl. No.: 16/055,408

(22) Filed: Aug. 6, 2018

Related U.S. Application Data
(63) Continuation-in-part of application No. 14/076,620, filed on Nov. 11, 2013, now abandoned.

(51) Int. Cl. A62C 3/02; A62C 37/36; G08B 17/00

(52) U.S. Cl. CPC A62C 3/0271; A62C 3/0214; G08B 17/005; A62C 37/36; A62C 3/0278; A62C 37/04

(57) ABSTRACT

A wildfire suppression system is shown that includes a detector that can identify a wildfire threat from an approaching wildfire. When a wildfire is detected, a fire suppression system is activated to pump a fire retardant product, such as water or foam, through a fire retardant distribution system to supply the fire retardant to a series of water dispersion devices that are positioned to protect a structure and a set of landscape elements such as trees, flowers, bushes, and shrubs. Various embodiments can include a fixed based non mobile wildfire suppression system having automatic notification to local fire and police authorities of the presence of the wildfire, and can also include local electrical power generating units that can provide the electrical power needed to operate and control the wildfire suppression system.

### CROSS-REFERENCE TO RELATED APPLICATIONS

This is a continuation-in-part of pending U.S. patent application Ser. No. 14/076,620 filed on Nov. 11, 2013 and the entire contents of that application are hereby incorporated by reference as if fully stated herein.

### STATEMENT REGARDING FEDERALLY SPONSORED RESEARCH OR DEVELOPMENT

Not Applicable.

### FIELD

The present disclosure relates to a fixed-base non-mobile system for use in protecting property from damage caused by wildfires.

### BACKGROUND

This section provides background information related to the present disclosure which is not necessarily prior art.

Throughout most of the southwestern and western part of North America homes and cites have been built in geographic areas that are very prone to sudden and unpredictable wildfires. When a wildfire rages through a community, the homes can be completely and irreparably destroyed or severely damaged. Perhaps even more traumatic is the loss of the contents of those homes that can include irreplaceable objects such as family photos, antiques, family heirlooms, and individual personal items such as jewelry, musical instruments, books, and even personal diaries. Additionally, the wildfire damage can also include loss of flowers, bushes, trees, and other landscape plants that may take years and even decades to replace and regrow. In many situations, the lost property can simply not be replaced at all.

As a result of the catastrophic damage that wildfires can cause, there is a pressing need for a wildfire suppression system that is capable of providing some protection to property from such damage or loss. There are some systems that have been generated over the years that have sought to provide homes and business with some protection against wildfires. In one invention, a cover is automatically deployed that intends to protect the foot print of the structure from fire. Although such devices may protect a building for a short period of time, the intensity and duration of wildfires can result in the overcoming of that protection with the result that the building is ultimately damaged or destroyed. Additionally, while such covers may temporarily protect the buildings themselves, such covers do not provide adequate protection of the plants, trees, and other types of landscaping that surround the building.

In a second invention, a minimal fire suppression system is installed onto the roof of the building. During a wildfire, the fire suppression system is activated to place a fire retarding product onto the roof shingles of the building. It is very hard to install such a system, however, in a manner that will properly protect the entire surface area of the roof and to ensure that that the sides of the building do not become damages by embers that are generated and blown by the wildfire. And, as is the problem with the first invention, such fire suppression systems are intended to protect only the building itself and does not provide any protection at all to the valuable flowers, bushes, trees, and other landscaping around the building.

In yet other previous inventions, the device is simply intended to be used as a fire break. In that invention, the firebreak is manually deployed in the path often approaching fire in an effort stop the fire from proceeding closer to the item to be protected. Such inventions fail to fully protect any buildings and fail to provide any automatic fire suppression or protection of any property when a wildfire is present.

One particularly fatal flaw in past inventions that use sprayers to apply water to endangered buildings is the use by those inventions of the water supplied by the local water utility. Dependence on the local water utility to supply the large amounts and volumes of water needed to properly protect a building and its landscaping disregards, the fact that many local water utilities depend on power sources that may not be available during significant wildfires. For example, when local water utility uses a common electrical power source to distribute the water throughout the local water utility lines to buildings in the community, the power lines to the water utility are often carried on utility poles that course through pastures and wooded areas. When a wildfire burns near such utility poles, the poles and electrical conductors on the utility poles can be severely damaged to the point where the electrical power needed by the local water utility is disrupted. Fire suppression inventions that rely on the water provided by local water utilities can easily find that the system does not have any water to distribute on a building to protect it from the approaching wildfire. The end result is again sever and catastrophic damage to both the building and the landscape that surrounds the building that was intended to be protected from the wildfire.

What is needed is a fixed-base non-mobile wildfire suppression system that automatically detects approaching wildfires, automatically activates a fire suppression system that can protect buildings and the landscaped area around the buildings, while also having a water supply system that does not depend on local water utilities.

### BRIEF SUMMARY OF THE INVENTION

This section provides a general summary of the disclosure, and is not a comprehensive disclosure of its full scope or all of its features.

In accordance with the various embodiments of the present invention, this invention relates to a fixed base non-movable wildfire suppression system having improved capabilities to provide some protection to fixed residential and commercial structures and to the landscape is near those structures. More specifically, certain embodiments of the invention provide a wildfire suppression system that allows for the automatic detection of an approaching wildfire followed by the full activation of an independently controlled wildfire suppression system that can help protect the structure and the landscape that surrounds the structure.

Further areas of applicability will become apparent from the description provided herein. The description and specific examples in this summary are intended for purposes of illustration only and are not intended to limit the scope of the present disclosure.

### DRAWINGS

In the accompanying drawings which form part of this specification:

FIG. 1 is a perspective view of one embodiment of the present invention showing one possible format for positioning the components of the wildfire suppression system;

FIG. 2 is a perspective view of one embodiment of the present invention showing the operation of one possible format for locating and connecting the piping and power distribution system to provide operating resources to components of the wildfire suppression system;

FIG. 2A is a perspective view of one embodiment of the present invention showing the command and communication system of one embodiment of the present wildfire suppression system;

FIG. 3 is a side view of the fire retardant dispersal device of one embodiment of the present wildfire suppression system;

FIG. 4 is a top view of the fire retardant dispersal device of one embodiment of the present wildfire suppression system; and

FIG. 5 is a top view of an exemplary layout of one embodiment of the present wildfire suppression system.

Corresponding reference numerals indicate corresponding parts throughout the several views of the drawings. The drawings described herein are for illustrative purposes only of selected embodiments and not all possible implementations, and are not intended to limit the scope of the present disclosure.

While one embodiment of the present invention is illustrated in the above referenced drawings and in the following description, it is understood that the embodiment shown is merely one example of a single preferred embodiment offered for the purpose of illustration only and that various changes in construction may be resorted to in the course of manufacture in order that the present invention may be utilized to the best advantage according to circumstances which may arise, without in any way departing from the spirit and intention of the present invention, which is to be limited only in accordance with the claims contained herein.

### DETAILED DESCRIPTION OF AT LEAST ONE PREFERRED EMBODIMENT OF THE INVENTION

In the following description, numerous specific details are set forth such as examples of specific components, devices, methods, in order to provide a thorough understanding of embodiments of the present disclosure. It will be apparent to a person of ordinary skill in the art that these specific details need not be employed, and should not be construed to limit the scope of the disclosure. In the development of any actual implementation, numerous implementation-specific decisions must be made to achieve the developer's specific goals, such as compliance with system-related and business-related constraints. Such a development effort might be complex and time consuming, but is nevertheless a routine undertaking of design, fabrication, and manufacture for those of ordinary skill.

In the art of wildfire suppression and protection, there are a number of critical issues that are not controllable or predictable. For example, the actual strength, speed, and path of any wildfire are strictly dependent upon the current present environmental conditions in which the wildfire exists or is approaching. For example, if recent weather has included a lot of rainfall, the otherwise combustible material available to the wildfire may not be as plentiful as when there has been drought recently in the vicinity of the wildfire. Also, the potentially combustible material available for burning by the wildfire is very unpredictable. For example, during the initial installation of any wildfire suppression or protection system there may be only sparse amounts of combustible material near a facility to be protected. Yet just one year later there may be large amounts of such combustible material that may have resulted from an especially good growing year for vegetation. The availability of water for use as a fire retardant for any wildfire suppression system can also be drastically effected by recent or current environmental conditions. For example, if the fire suppression system intends to use a nearby lake to obtain water as its fire retardant, drought may reduce the amount of water in that lake for such uses. In some situations, that may not be a problem, while in other conditions the reduced amount of water from the lake would reduce the amount of time the wildfire suppression system can be used at full operating power to protect a facility or the facility's landscape.

In light of these many unpredictable and uncontrollable environmental variables, it will be appreciated that while an exemplary preferred embodiment of the current wildfire suppression invention is disclosed herein, that exemplary preferred embodiment and any other embodiments described herein, may need to be periodically adjusted or modified to meet the specific requirements of any installation and applications of the present invention. For these same reasons, the present invention is intended to suppress or reduce damage caused by a wildfire—not to provide full protection against any and all damage that might result from any type of wildfire. The WSS is also intended in certain preferred embodiments to be a non-mobile fixed-based system that is intended to provide wildfire protection for single specific land surface area in which a residential or commercial structure can be protected by the WSS.

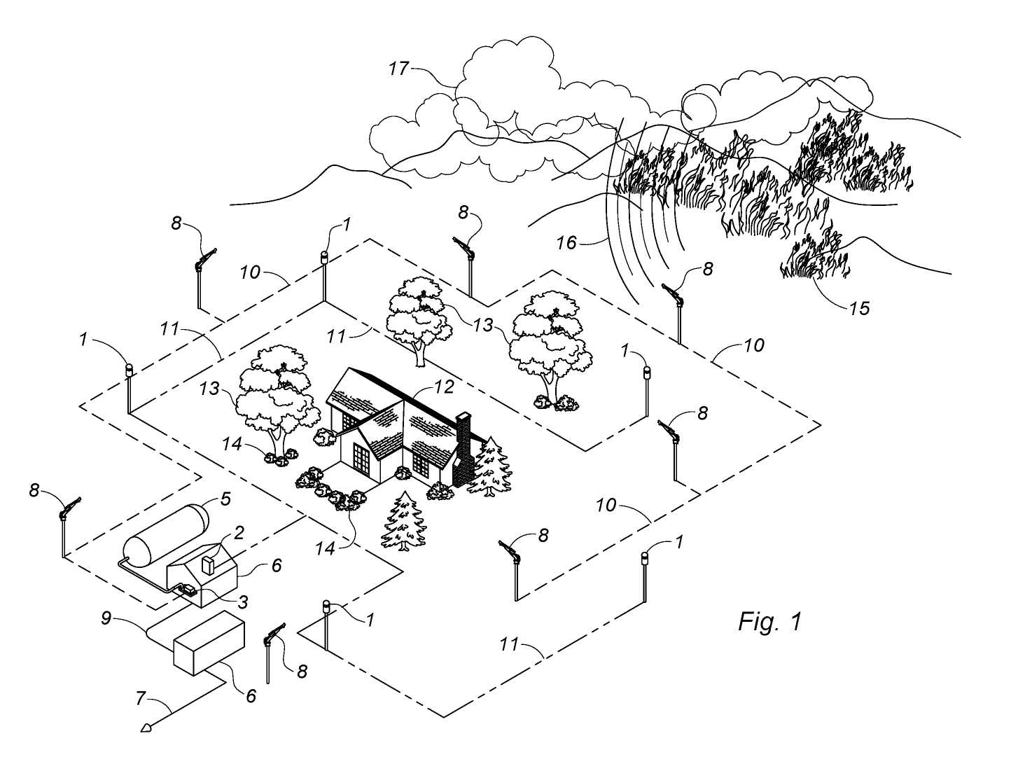

Referring now to FIG. 1, an exemplary preferred embodiment of the present invention, the Wildfire Suppression System (“WSS”) A is shown. The WSS in this embodiment is a fixed-base non-mobile system designed to suppress wildfire damage to a Specified Structure B, including building 12, and Specified Landscape C, including trees 13 and bushes 14, and includes at least one wildfire detection sensor 1, a computer based control and operation system 3, a plurality of fire retardant dispersion devices 5, a fire retardant pumping system 7, a supply of fire retardant product 9 to be dispersed by the fire retardant dispersion devices, a fire retardant distribution system for distributing the fire retardant product throughout the WSS as needed, and an electrical power distribution and communication system 11.

In alternative embodiments, the WSS can also include a local electrical power generation system for generating electrical power without dependence on the local electrical supply utility that might be inoperable during attack by a wildfire.

In a preferred embodiment, the WSS includes a wildfire detection sensor 1. The wildfire detection sensor 1 (FIG. 1) detects the presence of a flame 15, a smoke 17, or a set of climatic heat conditions 16 near the sensor. Thermal and visual imaging components within the wildfire detection sensors 1 can be used to analyze current and nearby conditions to monitor for fire hazards. By transmittal of at least one alarm signal, the wildfire detection sensor 1 communicates the detection of a danger that constitutes a fire hazard to the property and landscape being monitored by the WSS. When the wildfire detection sensor 1 transmit the alarm signal to the WSS, the WSS engages, disengages, and/or reengages WSS functions that operate and control the fire retardant dispersal system.

In a preferred embodiment, the wildfire detection sensor 1 communicates with the other components of the WSS by any type of wireless communication. In other embodiments, the wildfire detection sensor can communicate by hard wiring or by any other electromagnetic form of communication as long the signals communicated by the wildfire detection sensor are read by the appropriate component of the WSS that properly operates the fire retardant dispersal systems and any other primary or auxiliary WSS communication systems.

The detection range of the wildfire detection sensor 1 is adapted to meet the specific application, however, in a preferred embodiment of the current WSS system, the wildfire detection sensor can detect fire hazard or hazardous conditions that might warrant the operation of the fire retardant dispersal system of the WSS for a range up to about 5 miles. An example of an acceptable wildfire detection sensor is the “Flame Sniffer” Model 4C-V3 Series, 4C-V5 Series or 4C-Ex3 Series sensor as made by the FLAME SNIFFER Fire Detection and Intelligence networks.

In the present embodiment, the WSS also includes a computer based control and operation system 3. In the preferred embodiment, the computer system 3 is microprocessor based and can be composed of various subcomupter systems working in communication with each other to perform the necessary analysis necessary to detect the presence of fire hazards, to properly and fully operate the fire retardant dispersal systems, and execute the communications mandated by the particular application of the WSS. In this embodiment, the computer based control and operation system 3 is generally located in the protective housing 2.

The plurality of fire retardant dispersion devices 5 included in the present embodiment can be designed to disperse various types of fire retardant products. Of course, the primary fire retardant product in many applications will be water. In a preferred embodiment, the water source can be any reservoir of water that can supply an adequate amount of water for an adequate amount of time to allow the WSS to sufficiently operate to suppress the fire hazards that have been detected near the structure and landscape. In an exemplary installation of the WSS, where the structure is a building having 2,000 square feet positioned on a 1 acre lot with normal trees and shrubbery, the water reservoir should be able to provide between about 1,000 gpm and about 3,000 gpm of water at between about 40 psi and about 244 psi of water pressure.

In many embodiments, the water source will be a preinstalled reservoir tank 5 of sufficient size and shape to retain the amount of water as needed for the specific WSS application. In an exemplary installation, at least one water reservoir would be emplaced having a water holding capacity of about 2,000 gallons. In yet other embodiments, the water reservoir capacity can be between about 600 gallons and about 60,000 gallon and still remain within the scope of the present invention. It is preferred that the water reservoir in a standard WSS application be manufactured of rustproof material such as fiberglass. The water reservoir may be installed underground or above ground.

In alternative WSS embodiments, the water may be obtained from swimming pools, local ponds, streams, lakes or rivers. In such installations, however, care should be taken to ensure that the water is adequately filtered to prevent damage to the fire retardant dispersal components or clogging of the fire retardant dispersal piping.

In other alternative embodiments of the WSS, the fire retardant can be a fire retardant foam used in conjunction with the water, or rather than water. In such embodiments, a preferred foam would be Class A foam that is non-toxic, biodegradable and in concentrated form. The selected foam may also be fully approved by the USDA Forest Service as meeting all the requirements for forest use as a fire retardant foam. When a fire retardant foam is used, the WSS might also include components necessary to turn the foam concentrate into the dispersible foam that actually gets dispersed to suppress the wildfire.

The fire retardant dispersal devices 8 are located strategic locations around the Specified Structure B and Specified Landscape C to ensure that the necessary coverage of the fire retardant product can be achieved by dispersal of the fire retardant products by the fire retardant dispersal devices. An exemplary arrangement is disclosed in FIG. 1. In that arrangement, the fire retardant dispersal devices 8 are located near the corners of the property and directed generally inward toward Specified Structure B and Specified Landscape C. Referring to FIGS. 3 and 4, it is noted that each of the fire retardant dispersal devices 8 have at least two methods of establishing the range and direction of the dispersal of the fire retardant product. In FIG. 3 the fire retardant dispersal devices 8 can be adjusted by an elevation angle E to establish the pitch of the fire retardant dispersal devices to establish the range and reach of the fire retardant being dispersed by the fire retardant dispersal devices. FIG. 4 disclosed a view of the top of the fire retardant dispersal devices 8 to reveal the adjustment along the horizontal plane of the fire retardant dispersal devices such as to determine and establish the horizontal directional control of the fire retardant product being dispersed by the fire retardant dispersal devices.

In certain preferred embodiments of the present invention, the fire retardant dispersal devices 8 should be capable of dispersing fire retardant product at between about 50 gpm and about 1200 gm at a pressure of between about 40 psi and about 130 psi. In preferred embodiments, the fire retardant dispersal device 8 is intended to have a range of between about 100 feet and about 600 feet. It is of course appreciated by those of skill in the art that the combinations of gpm, psi, and distance requirements are generated by the specific application of each embodiment of the WSS. In an exemplary embodiment of the WSS, the plurality of fire retardant dispersal devices 8 should be operating at between about 1 gpm and about 5 gpm, at between about 80 psi and about 130 psi, and the range of the fire retardant product being dispersed by the fire retardant dispersal devices 8 should be between about 300 feet and about 620 feet.

The fire retardant pump system 7 of a preferred embodiment of the present invention includes a pump system capable of providing the fire retardant product to the fire retardant dispersal devices 8 at the proper pressure rate and distance as dictated by the specific installation of the WSS and as determined by the above. In a preferred embodiment, the fire retardant pump system 7 includes horizontal split case, vertical in-line, and vertical turbine design pump assembly. The fire retardant pump system may also include either an electric motor or a petroleum powered engine to turn the pump. Because the size of the fire retardant ump system will likely have a high capacity demand, most embodiments will require the inclusion of a motor controller system to start, run, and stop the fire electric motor or the petroleum based engine. In either case, the controller based computer operation system 3 controls the operation of elements of the fire retardant pump system.

In many preferred embodiments, the fire retardant pump system 3 will have the capacity of providing fire retardant product at the rate of between about 100 gpm and about 5,000 gpm at a pressure of between about 40 psi to about 130 psi. In an exemplary embodiment of the WSS, the fire retardant pump system 3 would supply fire retardant product at between about 1 gpm and about 5 gpm at about 130 psi.

To provide fire suppression of the wildfire, the present embodiment includes the supply of fire retardant product 9 to be dispersed by the fire retardant dispersions devices.

In order to properly place the fire retardant product as need to protect the Specified Structure B and Specific Landscape C, the current embodiment includes the fire retardant distribution system for distributing the fire retardant product throughout the WSS as needed. In a preferred embodiment, the piping system for distributing the fire retardant product is between about 3 inches diameter and about 6 inches diameter and can sustain an operating pressure of at least 300 psi.

To enable the proper activation of the several components of the current embodiment of the WSS, the present embodiment includes an electrical power distribution and communication system 11. In many preferred embodiments, the electrical power distribution systems will be capable of providing between about 22 KW and 150 KW of electrical power at a voltage of 120 volt AC and 240 Volt AC. The electrical power system 11 driven by electrical power or by either a petroleum-based fuel or a natural gas product and still remain within the intended scope of the present invention.

It is noted that the current embodiment of the WSS includes a wide variety of components and system controls and that these components generally require the components of the WSS to be assembled and install in a non-mobile fixed base configuration. Therefore, it is understood that the current embodiment is not intended to include any alternative embodiment that would allow for the plurality of fire retardant dispersion devices 5 to be movable or placed upon any device that would allow the placement of the plurality of fire retardant dispersion devices to moved or relocated from any position other than the placement of the plurality of fire retardant dispersion devices as originally installed during the installation of this embodiment of the WSS. It is further understood that in this embodiment of the WSS the plurality of fire retardant dispersion devices 5 are not mounted on a mobile device having an on board reservoir that contains a supply of the fire retardant product to be dispersed by plurality of fire retardant dispersion devices 5.

It is also noted that in the present embodiment the plurality of fire retardant dispersion devices 5 do not rotate for repositioning through the use of geared pinions or other similar mechanical devices. Instead, the plurality of fire retardant dispersion devices are horizontally repositionable by means of a bearing assembly.

In operation, the WSS is intended to detect approaching wildfires and then activate a fire suppressions system to protect a specific structure or property, and to protect any landscape property such as flowers, bushes, or trees that may need to be along with the specific structure. Thus, in one preferred embodiment of the WSS, the wildfire detection sensor 1 detects the presence of flame, smoke, heightened temperatures, or climatic conditions that that a wildfire is near the Specified Structure B and Landscape C. When that detection is made, the wildfire detection sensor 1 signals the computer based control and operation system 3 that the fire suppression sequence needs to be activated and that local fire or police authorities need to be notified. In alternative embodiments, the computer based control and operation system also activates an alarm at or near the Specified Structure B to notify any persons nearby that a wildfire is approaching and that evacuation, suppression, and protection procedures need to be followed.

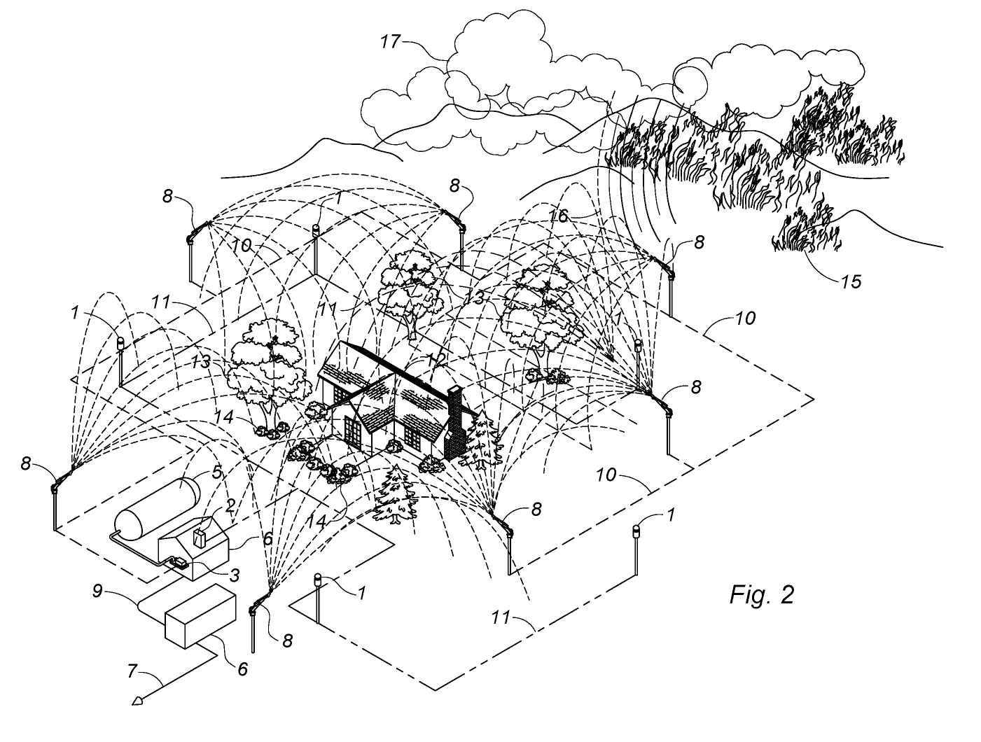

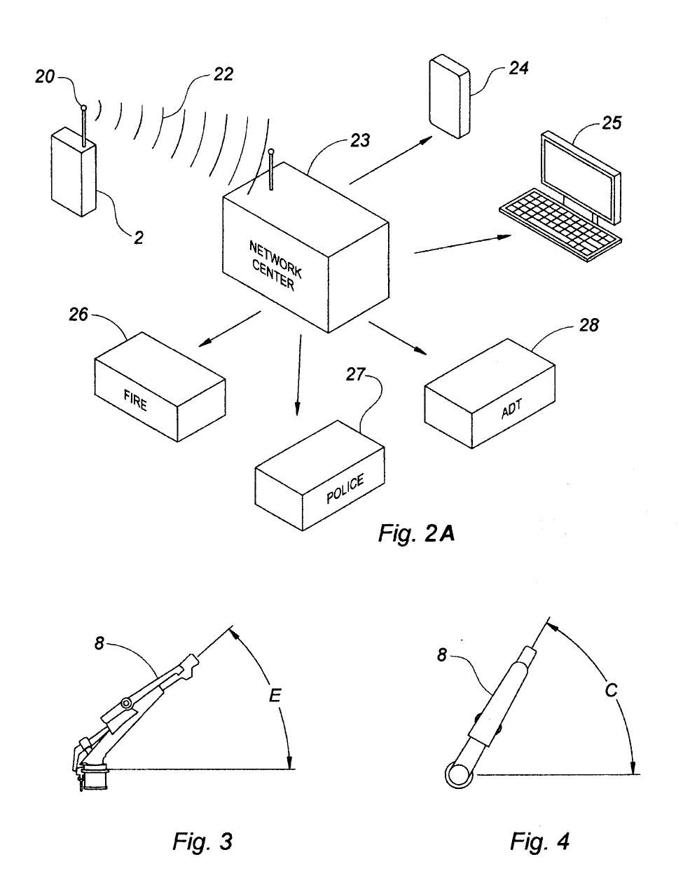

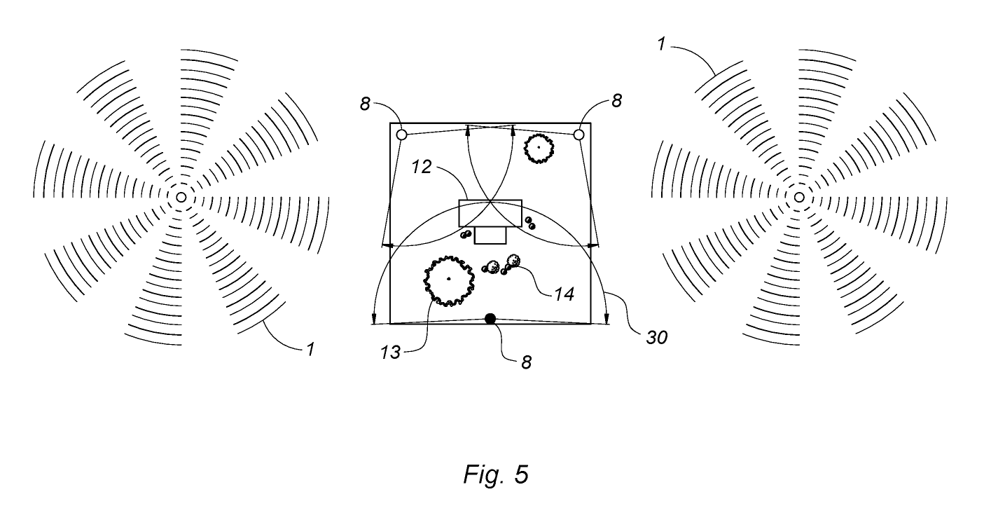

When the WSS is being activated after a wildfire hazard has been detected by the wildfire detections sensors 3, the computer based controller system activates the electrical power generation system to bring the fire retardant pump 7 online. When the fire retardant system operating pressure has been established the fire retardant is dispersed though the fire retardant dispersal devices 8 to flood the Specified Structure and the Specified Landscape with fire retardant to suppress the deleterious effects that the approaching wildfire may on the Structure and the Landscape. FIG. 2 shows an exemplary distribution pattern of the fire retardant product 9.

Although every wildfire has its own destructive characteristics, in an exemplary situation, the WSS would need to be able to provide fire suppression against the destructive properties of a wildfire for between about 30 minutes and about 1500 minutes.

Additionally, when a wildfire hazard has been detected, the WSS communication components may be adapted to signal a network center 23 (FIG. 2A) that in turn sends communications to fire departments 26, police 27, and/or alarm services 28 to notify those authorities of the impending catastrophe. In alternative embodiments of the present invention, the WSS communication components may also send communications to the owner of the Specified Structure and Landscape by transmittal of automated messages 22 to the owner's cell phone 20 or personal computer 25.

The foregoing description of the embodiments of the present invention has been provided for purposes of illustration and description. As various changes could be made in the above constructions without departing from the scope of the invention, it is intended that all matter contained in the above descriptions or shown in the accompanying drawings shall be interpreted as illustrative and not in a limiting sense.

It will also be seen in the above disclosure that several of the intended purposes of the invention are achieved, and other advantageous results obtained. Additionally, in the preceding description, numerous specific details are set forth such as examples of specific components, devices, methods, in order to provide a thorough understanding of embodiments of the present disclosure. It will be apparent to a person of ordinary skill in the art that these specific details need not be employed, and should not be construed to limit the scope of the disclosure.

The disclosure herein is also not intended to be exhaustive or to limit the invention to the precise forms disclosed. Individual elements or features of a particular embodiment are generally not limited to that particular embodiment, but, where applicable, are interchangeable and can be used in a selected embodiment, even if not specifically shown or described.

In the development of any actual implementation, numerous implementation-specific decisions must be made to achieve the developer's specific goals, such as compliance with system-related and business-related constraints. Such a development effort might be complex and time consuming, but is nevertheless a routine undertaking of design, fabrication and manufacture for those of ordinary skill. The scope of the invention should be determined by any appended claims and their legal equivalents, rather than by the examples given.

Terms such as “proximate,” “distal,” “upper,” “lower,” “inner,” “outer,” “inwardly,” “outwardly,” “exterior,” “interior,” and the like when used herein refer to positions of the respective elements as they are shown in the accompanying drawings, and the disclosure is not necessarily limited to such positions. Terms such as “first,” “second,” and other numerical terms when used herein do not imply a sequence or order unless clearly indicated by the context.

When introducing elements or features and the exemplary embodiments, the articles “a,” “an,” “the” and “said” are intended to mean that there are one or more of such elements or features. The terms “comprising,” “including,” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

It will be understood that when an element is referred to as being “connected,” “coupled,” “engaged,” or “engageable” to and/or with another element, it can be directly connected, coupled, engaged, engageable to and/or with the other element or intervening elements may be present. In contrast, when an element is referred to as being “directly connected,” “directly coupled,” “directly engaged,” or “directly engageable” to another element, there are no intervening elements present. Other words used to describe the relationship between elements should be interpreted in a like fashion (e.g., “between” versus “directly between,” “adjacent” versus “directly adjacent,” etc.).

1. A wildfire suppression system comprising:
at least one wildfire detection sensor;
at least one fire retardant dispersion device operatively connected to a computer controlled retardant pressure control to adjust a range that a fire retardant is to be dispersed and a computer controlled horizontal control to rotate the fire retardant dispersal device as much as a full 360 degrees around an axis vertical to the horizon and as much as 90 degrees vertically from the horizon to any horizontal direction or any vertical direction in which the fire retardant is to be substantially continuously dispersed within that hemispherical scope of dispersion wherein the at least one fire retardant dispersion device is not mounted on a mobile device having an on board reservoir that contains a supply of the fire retardant product to be dispersed by the fire retardant dispersions device;
a fire retardant distribution system to provide the fire retardant product to the fire retardant dispersion device;
a fire retardant pumping system for distributing the fire retardant product within the fire retardant distribution system;
a computer based control and operation system in operative communication with at least one of either the wildfire detection sensor, the fire retardant dispersion device, the fire retardant dispersion system, the fire retardant pumping system, or the electrical power and communication system;
an electrical power distribution and communication system for supplying at least one of either electrical power, data communications, and instructions to the components of the wildfire suppression system; and
wherein the wildfire suppression system and its components are a non-mobile and fixed based system.

2. The wildfire suppression system of claim 1 further comprising an electrical generator for supplying the electrical power to the wildfire suppression system.

3. The wildfire suppression system of claim 1 wherein the wildfire detection sensor operatively communicates with the computer based control and operation system through one of either wired or wireless communication.

4. The wildfire suppression system of claim 3 wherein the wildfire detection sensor detects the presence of a flame within the geographic region of at least one of either a structure or a landscape near the wildfire detection sensor.

5. The wildfire suppression system of claim 4 wherein the wildfire detection sensor detects the presence of smoke within the geographic region of at least one of either the structure or the landscape near the wildfire detection sensor.

6. The wildfire suppression system of claim 5 wherein the wildfire detection sensor detects the presence of excessive heat within the geographic region of at least one of either the structure or the landscape near the wildfire detection sensor.

7. The wildfire suppression system of claim 6 wherein the wildfire detection sensor detects the current climatic conditions within the geographic region of at least one of either the structure or the landscape near the wildfire detection sensor.

8. The wildfire suppression system of claim 7 wherein the wildfire detection sensor transmits at least one alarm signal to the computer based control and operation system when the wildfire detection sensor detects a value of at least one of either smoke, flame, or heat that exceeds a maximum value stored within the wildfire suppression system.

9. The wildfire suppression system of claim 8 wherein the computer based control and operation system operatively communicates with at least one of either the at least one fire retardant dispersion device, the fire retardant pumping system, the fire retardant distribution system for distributing the fire retardant product, or the electrical power distribution and communication system to activate the at least one fire retardant dispersion device to distribute the fire retardant to attempt to suppress a wildfire when the wildfire detection sensor communicates the at least one alarm signal to the computer based control and operation system.

10. The wildfire suppression system of claim 9 wherein the fire retardant contains water.

11. The wildfire suppression system of claim 9 wherein the fire retardant is a fire retardant foam approved by the USDA Forest Service as meeting all the requirements for forest use as fire retardant foam.

12. The wildfire suppression system of claim 11 wherein the control to adjust the range that the retardant dispersion device will disperse the fire retardant includes a pitch control to adjust the elevation of a nozzle component of the fire retardant dispersal device.

13. The wildfire suppression system of claim 12 wherein the control to adjust the horizontal direction that the retardant dispersion device will disperse the fire retardant includes a horizontal plane control to adjust the horizontal direction of the nozzle component of the fire retardant dispersal device.

14. The wildfire suppression system of claim 13 wherein the fire retardant pumping system further comprises a pump system having the capacity of providing the fire retardant product to the fire retardant dispersal device at a rate of between about 100 gpm and about 5,000 gpm and at a pressure of between about 40 psi to about 130 psi.

15. A process of suppressing a wildfire comprising the step of:
installing a wildfire suppression system wherein the wildfire suppression system and its components are a non-mobile and fixed based system;
detecting at least one of either smoke, temperature, or flame within the geographic region of an area to be protected from a wildfire;
generating an alarm signal from a detection sensor that detects at least one of either smoke, temperature, or flame within the geographic region of an area to be protected from a wildfire;
communicating the alarm signal to a computer based control and operation system;
communicating a signal to instruct a fire retardant dispersion system to take actions to attempt to suppress the wildfire when the wildfire is near enough to the area to protected such that the wildfire may damage elements of the area to be protected unless the wildfire is suppressed, wherein the wildfire retardant dispersion system includes a pump, a fixed base non-mobile fire retardant dispersal device operatively connected to a computer controlled retardant pressure control to adjust a range that a fire retardant is to be dispersed and a computer controlled horizontal control to rotate the fire retardant dispersal device as much as a full 360 degrees around an axis vertical to the horizon and as much as 90 degrees vertically from the horizon to any horizontal direction or any vertical direction in which the fire retardant is to be substantially continuously dispersed within that hemispherical scope of dispersion, wherein the fire retardant dispersal device is not mounted on a mobile device having an on board reservoir that contains a supply of the fire retardant product to be dispersed by the fire retardant dispersion device;
a set of components for operating and controlling the components of the fire retardant dispersion system;
dispersing of a fire retardant product by the fire retardant system to attempt to suppress the wildfire; and
utilizing power from an electrical power distribution and communication system to supply electrical power, data communications, and instructions to the components of the wildfire suppression system.

16. The process of suppressing wildfires of claim 15 wherein the step of detecting at least one of either smoke, temperature, or flame within the geographic region of the area to be protected from the wildfire includes the use of a wildfire detection sensor that operatively communicates with the computer based control and operation system through one of either wired or wireless communication, wherein the wildfire detection sensor detects the presence of at least one of either the flame within the geographic region of at least one of either a structure or a landscape near the wildfire detection sensor, the presence of the smoke within the geographic region of at least one of either the structure or the landscape near the wildfire detection sensor, the value of the temperature within the geographic region of at least one of either the structure or the landscape near the wildfire detection sensor, or the climatic conditions within the geographic region of at least one of either the structure or the landscape near the wildfire detection sensor, and wherein the wildfire detection sensor can transmit at least one alarm signal to the computer based control and operation system when the wildfire detection sensor detects a value of at least one of either smoke, flame, or heat that exceeds a maximum value stored within the wildfire suppression system.

17. The process of suppressing wildfires of claim 16 further comprising the step of notifying at least one of either fire protection, police authorities, or the owner of the area to be protected when the wildfire suppression system has detected the possible presence of the wildfire.

18. The process of suppressing wildfires of claim 17 further comprising the step of including a stand alone electrical power generator to supply electrical power to the electrical power distribution and communication system.

19. The process of suppressing wildfires of claim 18 wherein the area to be protected includes at least one of either a structure to be protected or a landscape area to be protected.
